(19) United States
(12) Patent Application Publication
(10) Pub. No.: US 2006/0054407 A1
(43) Pub. Date: Mar. 16, 2006

(54) Transmission lubrication system for towing and method

(76) Inventors: Kirk L. Wirth, West Bloomfield, MI (US); William J Watson III, Belleville, MI (US); Edward J. Greenan, Belleville, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/131,559

(22) Filed: May 18, 2005

Related U.S. Application Data
(60) Provisional application No. 60/589,281, filed on Jul. 20, 2004.

(51) Int. Cl. F16H 57/04

(52) U.S. Cl. 184/6.12

(57) ABSTRACT

A transmission lubrication system for a vehicle transmission includes a fluid collection chamber positioned to collect fluid thrown by a rotatable member within the transmission. Structure forming a flow passage extending from the fluid collection chamber is in fluid communication with a transmission component so that the collected fluid flows from the fluid collection chamber via the flow passage to the transmission component to lubricate the transmission component.

### CROSS REFERENCE TO RELATED APPLICATIONS

This application claims the benefit of U.S. Provisional Application No. 60/589,281, filed Jul. 20, 2004, which is hereby incorporated by reference in its entirety.

### TECHNICAL FIELD

The invention relates to the lubrication of a power transmission, especially during towing.

### BACKGROUND OF THE INVENTION

A power transmission for a vehicle contains many moving components that require lubrication. A typical transmission lubrication system includes lubricating oil circulated by a pump. The pump is powered by the vehicle engine. When the engine is turned off, such as during towing of the vehicle, the pump does not run and cannot circulate lubricating fluid to the transmission.

### SUMMARY OF THE INVENTION

A transmission lubrication system for a vehicle transmission is provided that lubricates transmission components, especially those that move during vehicle towing, when a power source for the vehicle is turned off. The transmission lubrication system includes a transmission component and structure forming a fluid collection chamber that is positioned with respect to the transmission component to collect fluid thrown by rotation of a rotating member within the transmission. Structure such as the transmission casing forms a flow passage which extends from the fluid collection chamber and is in fluid communication with the transmission component so that the collected fluid flows by gravity from the fluid collection chamber via the flow passage to lubricate the transmission component.

In one aspect of the invention the rotatable member, which may be an output chain or a gear, is located in the interior space of the transmission and is connected to the power source and to the wheels. The rotatable member rotates by the power source when the power source is on and rotates by rotation of the wheels when the power source is off and the vehicle is being towed. The rotatable member contacts fluid contained in the transmission and throws the fluid such that it is collected in the fluid collection chamber. The fluid collection chamber may include a spill feature permitting the collected fluid to spill out of the fluid collection chamber when a predetermined level of fluid is collected.

In another aspect of the invention, the transmission casing includes an extension positioned so that the projected fluid coats the extension and is then dripped from the extension into the fluid collection chamber.

In yet another aspect of the invention, the flow passage includes a valve that restricts flow when the power source is powering the vehicle and is selectively openable to permit flow from the fluid collection chamber to the transmission component when the power source is not powering the vehicle (i.e., when the vehicle is being towed).

In still another aspect of the invention, the branch passage extends from the flow passage and permits fluid to flow from the flow passage to another transmission component for lubrication thereof. A valve may be located in the branch passage that is selectively operable to permit flow to the other transmission components when a predetermined level of fluid pressure exists in the flow passage.

A method for lubricating a vehicle transmission during towing of the vehicle includes towing the vehicle such that wheels on the vehicle rotate. A rotatable member located within the transmission rotates through lubricating fluid contained in the transmission in response to the rotation of the wheels to throw the lubricating fluid off of the rotatable member. The method then includes collecting the thrown fluid. Finally, the method includes directing the collected fluid onto a transmission component for lubrication thereof.

Optionally, after the rotating step, the method may include coating the casing with the thrown fluid and dripping the thrown fluid from the coated casing such that the dripped fluid is collected.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a first vehicle being towed by a second vehicle;

FIG. 2 is a schematic perspective illustration of a transmission lubrication system including a rotating member for lubricating the transmission of the towed vehicle of FIG. 1; and

FIG. 3 is a schematic illustration in partial perspective and partial cross-sectional view of the transmission lubrication system of FIG. 2, with the rotating member not shown.

### DESCRIPTION OF THE PREFERRED EMBODIMENTS

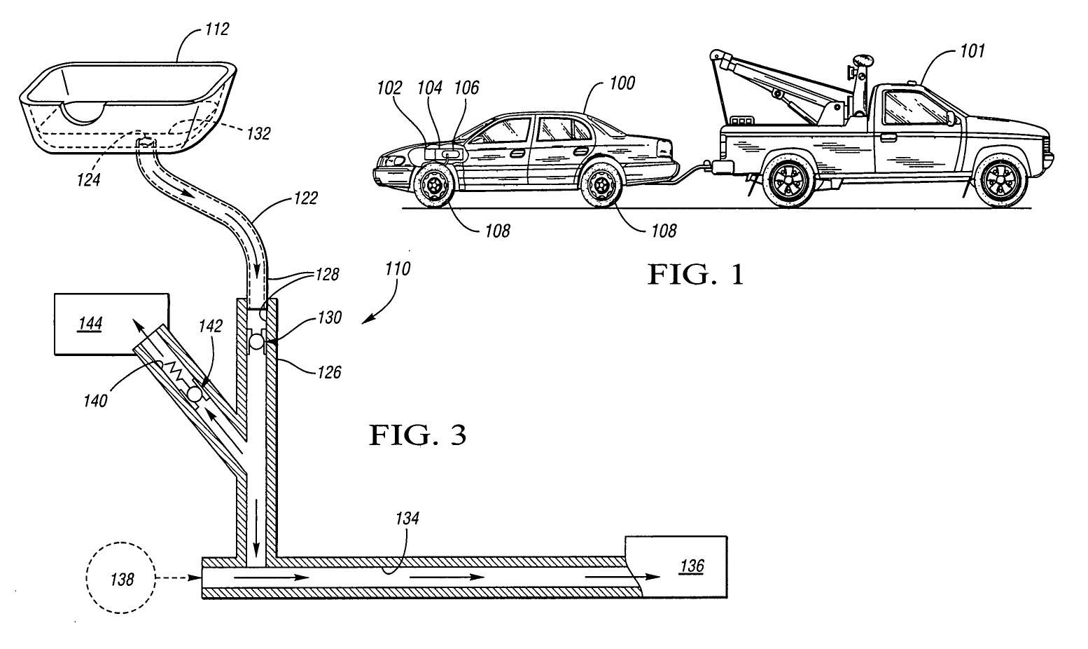

Referring to the drawings, wherein like reference numbers refer to like components, FIG. 1 shows a towed vehicle 100 being towed by a towing vehicle 101. The towed vehicle 100 includes a power source, such as an engine 102 that during normal driving operation powers the transmission 104 to rotate the wheels 108. A rotating member, such as an output chain 106, drives a differential mechanism (not shown) operatively connected to the wheels 108 to rotate the wheels, as is typical. As an alternative to the output chain 106, the rotating member may be a gear 143 (or multiple gears) shown in phantom and rotating about the same axis I as the left hand side of the chain 106. During normal driving operation, a pump (not shown) is powered via the engine 102 to provide lubrication to internal moving components of the transmission 104 to prevent frictional heat damage to the components. During towing, the pump is not powered and therefore cannot supply lubricant to the moving components in the transmission 104.

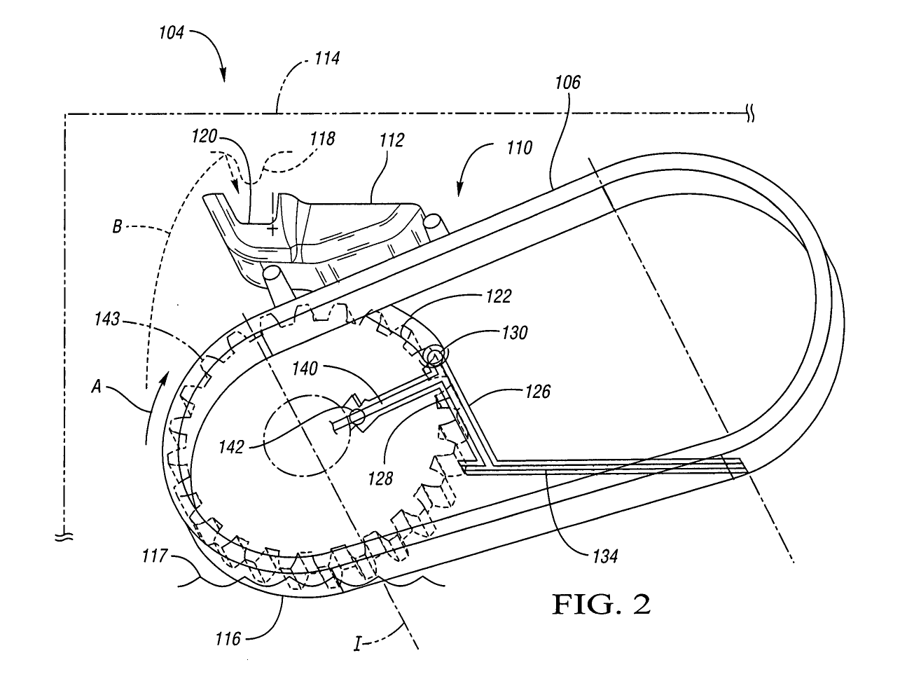

Referring to FIG. 2, a transmission lubrication system 110 includes a fluid collection chamber 112, also referred to herein as a tub. Any structure capable of collecting fluid as described herein, whether or not having a tub-like formation, may serve as a fluid collection chamber within the scope of the invention. The tub 112 is mounted to or integrally formed on an internal casing wall 114 (shown in phantom) of the transmission 104. The tub 112 is located generally above the chain 106. A lower portion 116 of the chain 106 contacts fluid 117 collected toward the bottom of the transmission as it rotates clockwise as indicated by the arrow A. As the chain continues to rotate, centrifugal force throws some of the fluid off of the chain 106. The thrown fluid may splash against the wall 114, coating the wall 114 or splash off of the wall 114 into the tub 112, as indicate by the path of arrow B. Thrown fluid that coats the wall 114 may collect on an extension 118 (i.e., a detent) formed on or mounted to the wall 114 and positioned to drip the collected fluid into the tub 112 located below. (It should be noted that the lubrication system 110 would also function if the chain 106 were rotating counterclockwise, as it would be if the vehicle 100 of FIG. 1 were facing the opposite direction than that shown during towing. In that instance, fluid would be thrown from the chain 106 in a different pattern, but would still be collected in the tub 112). The tub 112 is formed with a spillover lip 120, which causes collected fluid 132 to spill out from the tub when it reaches a predetermined level (i.e., the bottom of the lip 120) to maintain no more than the predetermined level of fluid in the tub 112.

Referring to FIG. 3, a tube 122 extends downward from an opening 124 in the tub 112 and connects to structure 126, the tube 122 and the structure 126 together forming a first flow passage 128. The structure 126 may be the transmission casing or other structure within the transmission forming a flow passage. A first ball check valve 130 prevents flow in the first flow passage 128 when the engine 102 is powering the vehicle and opens to permit flow (via gravity from tube 122 to structure 126) when the engine 102 is not powering the vehicle, but the wheels are nevertheless turning (i.e., during towing). Fluid 132 collected in the tub 112 flows down the first flow passage 128 to travel along a connected lower passage 134 formed in the structure 126 to transmission components such as bearings 136 for the chain 106 (fluid flow is represented by arrows shown in the various passages). The lower passage 134 may be the passage used during normal driving operation to transfer lubricating fluid from a pump 138 to the bearings 136. However, as discussed above, the pump 138 is not powered during towing, and does not assist in lubricating the bearings or other transmission components (such as gears, bearings, washers, clutch plates and bushings) during towing.

A branch passage 140 is fluidly connected to the first flow passage 128. A second ball check valve 142 which is preferably spring loaded is housed in the branch passage 140. When the pressure in the first flow passage 128 downstream of the first check valve 130 reaches a predetermined level, the second check valve 142 permits flow through the branch passage 140 and beyond the valve 142 toward other transmission components 144.

Accordingly, the lubrication system 110 permits lubrication of transmission components during vehicle towing (i.e., during an engine off condition) by allowing fluid collected in the tub 112 to flow through the first flow passage 128. Additionally, the branched formation of the flow passages 128 and 140 permits lubrication of transmission components 136 and 144 which may be located on separate axes within the transmission 104.

While the best modes for carrying out the invention has been described in detail, those familiar with the art to which this invention relates will recognize various alternative designs and embodiments for practicing the invention within the scope of the appended claims.

1. A transmission lubrication system for a vehicle with a transmission, the transmission lubrication system comprising:
a transmission component;
structure forming a fluid collection chamber positioned to collect fluid thrown by a rotatable member of the transmission; and
structure forming a flow passage extending from said fluid collection chamber and in fluid communication with said transmission component such that the collected fluid flows from said fluid collection chamber via said flow passage to said transmission component, thereby lubricating said transmission component.

2. The transmission lubrication system of claim 1, wherein the vehicle includes wheels and a power source for powering the transmission connected to the transmission, and the transmission lubrication system further comprising:
said rotatable member being operatively connected to the power source and to the wheels such that said rotatable member is rotatable by the power source when the power source powers the transmission and is rotatable by rotation of the wheels when the vehicle is being towed.

3. The transmission lubrication system of claim 2, wherein said transmission component is a bushing operatively connected to said rotatable member such that said bushing rotates when said rotatable member rotates during towing.

4. The transmission lubrication system of claim 2, wherein said rotatable member is one of an output chain and a gear.

5. The transmission lubrication system of claim 1, wherein the vehicle includes a power source, and the transmission lubrication system further comprising:
a valve mounted within said flow passage restricting flow within said flow passage when said power source is powering said vehicle and selectively openable to permit flow from said fluid collection chamber to said transmission component when said power source is not powering said vehicle.

6. The transmission lubrication system of claim 1, further comprising:
a branch passage extending from said flow passage and permitting fluid to flow from said flow passage to another transmission component via said branch passage.

7. The transmission lubrication system of claim 6, further comprising:
a check valve positioned in said branch passage and selectively operable to permit flow to said another transmission component via said branch passage when a predetermined level of pressure is present in said flow passage.

8. The transmission lubrication system of claim 7, wherein said valve in said branch passage is a spring-loaded ball check valve.

9. The transmission lubrication system of claim 1, wherein said fluid collection chamber includes a spill feature permitting collected fluid to spill out of said fluid collection chamber when a predetermined level of fluid is collected in said chamber.

10. The transmission lubrication system of claim 1, wherein the transmission includes a transmission case; and
wherein said structure forming a flow passage is the transmission case.

11. A transmission for a vehicle having a power source and wheels, the transmission comprising:
a casing defining an interior space and configured to contain lubricating fluid within said interior space;
a rotatable member positionable within said interior space to be in contact with the lubricating fluid and operably connectable to the power source and to the wheels such that said rotatable member is rotatable by the power source when the power source powers the transmission and is rotatable by rotation of the wheels when the vehicle is being towed, wherein said rotatable member throws the lubricating fluid when said rotatable member is rotated by the wheels;
a transmission component; and
a fluid collection chamber positionable within said interior space in fluid communication with said transmission component and operable to collect the thrown lubricating fluid and communicate the fluid to said transmission component for lubrication thereof.

12. The transmission of claim 11, further comprising:
structure forming a flow passage extendable from said fluid collection chamber to communicate fluid from said fluid collection chamber to said transmission component when said fluid collection chamber is positioned within said interior space.

13. The transmission of claim 12, further comprising:
another transmission component;
a branch passage positionable to extend from said flow passage to permit fluid flow to flow from said flow passage to lubricate said another transmission component.

14. The transmission of claim 13, further comprising:
a check valve positionable in said branch passage and selectively openable to permit flow to said another transmission component via said branch passage when a predetermined level of fluid pressure is present in said flow passage.

15. The transmission of claim 11, wherein said casing forms a flow passage extendable from said fluid collection chamber to communicate fluid from said fluid collection chamber to said transmission component when said fluid collection chamber is positioned within said interior space.

16. The transmission of claim 15, further comprising:
a valve mountable within said flow passage and operable to restrict flow within said flow passage when said power source is powering said vehicle and selectively openable to permit flow within said flow passage when said power source is not powering said vehicle.

17. The transmission of claim 11, wherein said fluid collection chamber includes a spill feature configured to permit collected fluid to spill out of said fluid collection chamber when a predetermined level of fluid is collected in said chamber.

18. The transmission of claim 11, wherein said casing includes an extension positioned such that the projected lubricating fluid coats said extension and drips therefrom into said fluid collection chamber.

19. A method for lubricating a vehicle transmission containing lubricating fluid during towing of the vehicle, the method comprising:
towing the vehicle such that wheels on the vehicle rotate;
rotating a rotatable member located within the transmission through the lubricating fluid in response to the rotation of the wheels to throw the fluid within the transmission;
collecting the thrown fluid; and
directing the collected fluid onto a transmission component for lubrication thereof.

20. The method of claim 19, wherein the transmission includes a casing, and the method further comprising:
after said rotating step, coating the casing with the thrown fluid; and
dripping the thrown fluid from said coated casing such that the dripped fluid is collected.
